(19) United States
(12) Patent Application Publication
(10) Pub. No.: US 2018/0205704 A1
(43) Pub. Date: Jul. 19, 2018

(54) WEB FILTER WITH INSTANT ALERTS

(71) Applicants: Eric Terry, Waukee, IA (US); Robert Jorgensen, Casper, WY (US)

(72) Inventors: Eric Terry, Waukee, IA (US); Robert Jorgensen, Casper, WY (US)

(21) Appl. No.: 15/871,180

(22) Filed: Jan. 15, 2018

Related U.S. Application Data
(60) Provisional application No. 62/447,248, filed on Jan. 17, 2017.

(51) Int. Cl. H04L 29/06; H04L 12/58; H04L 29/08

(52) U.S. Cl. CPC H04L 63/0236; H04L 67/02; H04L 51/24

(57) ABSTRACT

A web filter system is presented that not blocks harmful web content and provides an instantaneous message to an accountability partner of the user seeking to access harmful internet content so they can intervene. The system includes a web filter software application that is installed on the internet enabled devices of a user. The application inspects all traffic and communicates with an API to determine whether to allow, block, or redirect either specific traffic or all traffic through a transport mechanism to a filter in the cloud for further filtering, regardless of how the internet enabled device connects to the internet. The system also includes a router that establishes a home electronic network that inspects all internet traffic that occurs through the router and communicates with an API to determine whether to allow, block, or redirect traffic through a transport mechanism to a filter in the cloud.

### CROSS REFERENCE TO RELATED APPLICATIONS

This application claims the benefit of United States Patent and Trademark Office Provisional Application No. 62/447,248 which was filed on Jan. 17, 2017, the entirety of which is incorporated herein by reference.

### FIELD OF THE ART

This disclosure relates to the internet. More specifically, and without limitation, this disclosure relates to an internet filter that provides instant alerts to a user's support network such as a parent or accountability partner.

### BACKGROUND

Without question the internet is an amazing resource and a source of unending information. The internet has provided capabilities and benefits never before realized and therefore the internet is an overwhelming source of good.

One of the great benefits of the internet is that it is in many ways uncontrolled and in many ways uncontrollable. That is, the internet is not constrained by geographic or political boundaries. The internet does not abide by societal norms of political correctness. Instead, essentially anyone can provide any content they desire and this content is accessible to anyone around the world regardless of whether the information is factually accurate, violent, harmful or outside of societal norms.

The unfettered access to harmful information may not be enticing to many internet users who will never seek out this information. However, unfettered access to harmful information may be very dangerous to curious young minds, to those who suffer from an addiction, to the mentally impaired, to those suffering from post-traumatic stress syndrome, or to others with various vulnerabilities, weaknesses, or conditions.

In an attempt to prevent access to harmful information on the internet various web filtering systems have been developed. These prior art web filters try to prevent access to harmful information by blocking the content in various manners. However, every prior art web filter has various limitations and do not prevent access to all harmful information. In addition, prior art web filters can be inactivated, uninstalled, removed or otherwise disabled.

Furthermore, while prior art web filters attempt to prevent access to harmful information by blocking access to this content, prior art web filters do not address the underlying issues such as addiction or early interest in harmful content. In addition, prior art web filter systems do not involve the user's support network as part of the process of preventing access to harmful content. By providing timely information to the user's support network, such as a parent or an accountability partner, this allows a safe conversation to occur about appropriate internet usage and the underlying reasons why the user sought out the harmful information. Early intervention by a user's support network, such as a parent or an accountability partner, can help prevent problems before they take root and can help stop interest from turning into addiction and other damaging behaviors.

Therefore, for all the reasons stated above, and the reasons stated below, there is a need in the art for an improved web filter system.

Thus, it is a primary object of at least one embodiment to provide a web filter system that improves upon the state of the art.

Another object of at least one embodiment is to provide web filter system that involves the user's support network, such as an accountability partner or parent in the filtering and blocking process.

Yet another object of at least one embodiment is to provide web filter system that provides early detection of harmful internet activity.

Another object of at least one embodiment is to provide web filter system that provides instant alerts to the user's support network, such as an accountability partner or parent of harmful internet activity.

Yet another object of at least one embodiment is to provide web filter system that is easy to use.

Another object of at least one embodiment is to provide web filter system that is difficult to work around.

Yet another object of at least one embodiment is to provide web filter system that does not substantially inhibit safe internet activities.

Another object of at least one embodiment is to provide web filter system that can be utilized with practically any internet enabled device.

Yet another object of at least one embodiment is to provide web filter system that helps prevent addiction.

Another object of at least one embodiment is to provide web filter system that blocks harmful internet content.

Yet another object of at least one embodiment is to provide web filter system that helps to prevent or stop addiction relapses from occurring.

Another object of at least one embodiment is to provide web filter system that is relatively inexpensive to apply.

Yet another object of at least one embodiment is to provide web filter system that does not substantially slow down internet operation.

Another object of at least one embodiment is to provide web filter system that can help prevent interest from turning into addiction.

These and other objects, features, or advantages of at least one embodiment will become apparent from the specification, figures and claims.

### SUMMARY

A web filter system is presented that not only blocks harmful web content, but provides an instantaneous or simultaneous message to an accountability partner of the user seeking to download harmful internet content. The message informs the user's accountability partner of the user's attempt to download harmful internet content thereby enabling the accountability partner to intervene. The system includes a web filter software application that is installed on the internet enabled devices of a user. The filtering software is either installed in an application on an internet capable device which inspects all internet traffic on the device regardless of whether the device connects to the internet through a home electronic network established by a router or other network device, or through a mobile electronic network. The filtering software intercepts all internet traffic and communicates with a cloud web service to allow, block, or redirect internet requests based on rules configured in the user's profile thus preventing unwanted or inappropriate content from being displayed to the user. Additionally all traffic or some subset of traffic is redirected using one of any possible transport mechanisms such as VPN, Proxy, or other, to a cloud filter which blocks harmful internet content from being returned to the user and sends a message to the accountability partner. A history of the traffic processed on the device is kept on the device and is periodically sent to the cloud web services to be stored on the user's account for review. If content is accessed that the user has designated as an alert the local history is immediately uploaded to the cloud web services, which immediately sends an alert to the parent or accountability partner.

### BRIEF DESCRIPTION OF THE DRAWINGS

FIG. 1 is a plan view of the web filter system described herein.

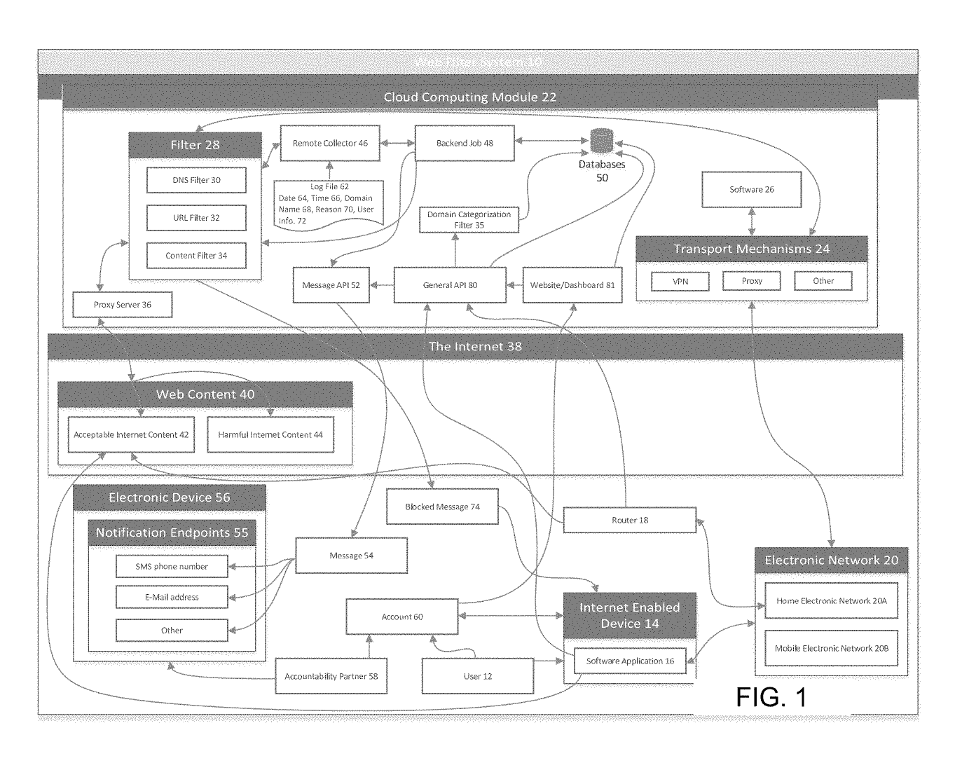

### DETAILED DESCRIPTION

In the following detailed description, reference is made to the accompanying drawings which form a part hereof, and in which is shown by way of illustration specific embodiments in which various embodiments of the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the invention.

With reference to the FIGURES, a web filter system 10 (or system 10) is presented that is formed of any suitable size, shape and design and is configured to filter harmful content while also providing alerts to a user's accountability partner. In the arrangement shown, as one example, the web filter system 10 includes a user 12 having an internet abled device 14 with a software application 16, a router 18, an electronic network 20 that includes a home electronic network 20A and a mobile electronic network 20B, a cloud computing module 22, a Transport Mechanism 24, software 26, a filters 28 including a DNS filter 30, a URL filter 32, a content filter 34 among other filters, a proxy server 36, the internet 38, web content 40 including acceptable internet content 42 and harmful internet content 44, a remote collector 46, a backend job 48, database(s) 50, a message API 52 configured to send a message 54 to an electronic device 56 of an accountability partners 58, General API 80, Website/Dashboard 81, among other components as is further described herein. While the elements identified above are identified in the singular, this is for convenience and clarity. It is hereby contemplated that there may be any number of the above elements.

User:

In the arrangement shown, as one example, web filter system 10 includes one or more users 12. User 12 is any person or group of people who would benefit from the use of web filter system 10. User 12 may be a person struggling with an addiction, such as an addiction to pornography as one example, who wants to block access to harmful internet content 44 as well as have notifications be provided to their accountability partner 58, such as a friend, an addiction buddy, a parent, a spouse, or any other person or persons. User 12 may be a young person whose parent wants to protect them from harmful internet content 44 and to prevent interest from turning into addiction. User 12 may be a mentally handicapped or mentally impaired person whose guardian wants to prevent access to harmful internet content 44. User 12 may be a group of people that have access to internet enabled device 14, such as a classroom of students that all use the same communal laptop or tablet. User 12 may be any other person or group.

Internet Enabled Device:

In the arrangement shown, as one example, web filter system 10 includes one or more internet enabled devices 14. Internet enabled device 14 is any internet enabled device used by user 12 to retrieve information or content from the internet 38. Examples of internet enabled device 14 include a smart phone, laptop, desktop computer, tablet, internet enabled television, an internet enabled watch, or any other internet enabled device 14 that can be used to conduct searches of the internet 38 and/or download information from the internet 38. Any one user 12 may have multiple internet enabled devices 14 that are all associated to the user 12 through a single account 60.

Account:

In the arrangement shown, as one example, web filter system 10 includes accounts 60. User 14, or a person on behalf of user 14, establishes an account 60 with the Website/Dashboard 81 and/or Software Application 16 using an internet enabled device (which may be one of the internet enabled devices 14) and provides various information to Cloud Computing Module 22 such as the user's name, address, payment information, the type of information they want blocked (such as pornography, violent content, terrorism-related, foul language, racism, or any other category of harmful internet content 44), and any other information needed regarding user 14. One or more accountability partners 58 are also established through account 60.

Web Filter Software Application:

In the arrangement shown, as one example, web filter system 10 includes web filter software application 16. Web filter software application 16 is any application, software, module and/or program that can be installed on internet enabled device 14 that facilitates the operation of web filter system 10. In another manner of speaking, web filter software application 16 is any self-contained program or piece of software designed to fulfill a particular purpose when installed on internet enabled device 14. In one arrangement, as one example, when using an android smart phone or tablet, user 12 searches the Google Play Store and downloads web filter software application 16 onto the android smart phone or tablet. As another example, when using an apple smart phone or tablet, user 12 searches the Apple App Store and downloads web filter software application 16 onto the Apple smart phone or tablet. Once downloaded (and account 60 is established—which may occur before or after downloading web filter software application 16) web filter software application 16 is installed on the internet enabled device 14. This process is repeated for all internet enabled devices 14 the user 12 wants to enroll in the web filter system 10.

Once web filter software application 16 is installed on internet enabled device 14, web filter software application 16 inspects all internet traffic from internet enabled device 14 and communicates with General API 80 to determine whether to allow, block, or redirect either specific traffic or all traffic through Traffic Transport Mechanism 24 to Filter 28, as is further described herein. This internet traffic from internet enabled device 14 occurs over electronic network 20, which may be the home electronic network 20A which goes through router 18, or alternatively which may be a mobile electronic network 20B.

As such, by installing web filter software application 16 on internet enabled device 14 this prevents the internet enabled device 14 from accessing harmful internet content 44 regardless whether the internet enabled device 14 accesses the internet through the home electronic network 20A, a mobile electronic network 20B, or any other electronic network 20.

Router:

In the arrangement shown, as one example, web filter system 10 includes router 18. Router 18 is any networking device that inspects all traffic and communicates with General API 80 to determine whether to allow, block, or redirect either specific traffic or all traffic through Traffic Transport Mechanism 24 to Filter 28. In the arrangement shown, as one example, router 18 establishes the wired and/or wireless home network. In one arrangement, as one example, router 18 is configured to, or pre-programmed to, inspect all traffic and communicate with General API 80 to determine whether to allow, block, or redirect either specific traffic or all traffic through Traffic Transport Mechanism 24 to Filter 28. As such, in this arrangement, all internet traffic is filtered. This is regardless whether web filter software application 16 is installed on the internet enabled device 14 that accesses the internet. As such, by installing router 18 this prevents any internet enabled device 14 that connects to home electronic network 20A from accessing harmful internet content 44 as all internet traffic is inspected and either allowed, blocked, or redirected through Traffic Transport Mechanism 24 to Filter 28 as dictated by responses from General API 80 and the other components of system 10.

As an example, when router 18 is installed on the home electronic network 20A and a child of the user 12 has a number of friends over, each of them with their own smart phone (internet enabled device 14) that does not have web filter software application 16 installed thereon, when these children perform internet searches router 18 automatically inspects all traffic and communicates with General API 80 to determine whether to allow, block, or redirect either specific traffic or all traffic through Traffic Transport Mechanism 24 to Filter 28 which effectively filters all internet content as is further described herein. As such, by installing router 18 on the home electronic network 20A this prevents others from accessing harmful internet content 44 thought the home electronic network 20A.

Electronic Network:

In the arrangement shown, as one example, web filter system 10 includes electronic network 20. Electronic network 20 is any electronic system that facilitates the transfer of information between computing devices. Electronic network 20 maybe a wired electronic network that transmits information through wired connection between computing devices. Electronic network 20 maybe a wireless electronic network that transmits information through wireless connection between computing devices. Electronic network 20 maybe a combination of a wired electronic network and a wireless electronic network that transmits information through both wired connection and wireless connection between computing devices.

In one arrangement, electronic network 20 is an electronic network 20 within the home (or office or any other location, building or facility) of the user 12 and therefore is known as home electronic network 20A. Home electronic network 20A may be a wired network, a wireless network or a combination of a wireless network and a wired network. In one arrangement, home electronic network 20A includes router 18 that is configured to, or pre-programmed to, inspect all internet traffic from any internet enabled device 14 connected to home electronic network 20A and communicates with General API 80 to determine whether to allow, block, or redirect either specific traffic or all traffic through Traffic Transport Mechanism 24 to Filter 28. As such, in this arrangement, all internet traffic is filtered. This is regardless whether web filter software application 16 is installed on the internet enabled device 14 that accesses the internet. As such, by installing router 18 this prevents any internet enabled device 14 that connects to home electronic network 20A from accessing harmful internet content 44 as all internet traffic is inspected and either allowed, blocked, or redirected through Traffic Transport Mechanism 24 to Filter 28 as dictated by responses from General API 80 and the other components of system 10.

Alternatively, when home electronic network 20A does not include router 18 that is pre-programmed to inspect all internet traffic and either allow, block, or redirect it through Traffic Transport Mechanism 24 to Filter 28 as dictated by responses from General API 80, when accessing the internet 38 through home electronic network 20A it is web filter software application 16 that inspects the traffic and communicates with General API 80 to determine whether to allow, block, or redirect either specific traffic or all traffic through Traffic Transport Mechanism 24 to Filter 28 to filter the internet traffic.

In another arrangement, electronic network 20 is an electronic network 20 outside of the home of the user 12 and therefore is known as a mobile electronic network 20B. Mobile electronic network 20B may be any wired network, wireless network or a combination of a wireless network and a wired network outside of the user's home. As the user's interactions with mobile electronic network 20B are often intermittent or when in transit, it is impossible to install a physical router (such as router 18) that inspects all traffic. As such, in this arrangement, web filter software application 16 inspects all network traffic from internet enabled device 14 and communicates with General API 80 to determine whether to allow, block, or redirect either specific traffic or all traffic through Traffic Transport Mechanism 24 to Filter 28. As such, by installing web filter software application 16 on internet enabled device 14 this prevents accessing harmful internet content 44 through internet enabled device 14 regardless how internet enabled device 14 accesses the internet as all internet traffic is inspected and either allowed, blocked, or redirected through Traffic Transport Mechanism 24 to Filter 28 as dictated by responses from General API 80 and the other components of system 10.

Cloud Computing Module:

In the arrangement shown, as one example, web filter system 10 includes cloud computing module 22. Cloud computing module 22 is formed of any system or systems that connects and facilitates the operation of various components of the web based filter system 10. In one arrangement, as is shown, cloud computing module 22 is an internet-based computing system that provides shared computer processing, resources and data to a plurality of other computers and devices. In one arrangement, as is shown, cloud computing module 22 enables ubiquitous, on-demand access to a shared pool of configurable computing resources (such as servers, storage, processing, applications, data, and services). In the arrangement shown, as one example, cloud computing module 22 connects and interconnects Traffic Transport Mechanisms 24, Software 26, Filter 28, Remote Collector 46 Backend Job 48, MessageAPI 52, Database(s) 50, General API 80 and Website/Dashboard 81. In the arrangement shown, as one example, cloud computing module is connected to by internet enabled device through http/https web access, web service API calls, mobile electronic network 20B, home electronic network 20A and/or through router 18.

Cloud computing module 22 employs cloud computing principles and therefore by connecting the components of the web filter system 10 through cloud computing module 22 using cloud computing principles provides many benefits such as agility, cost reduction, device and location independence, ease of maintenance, centralization of infrastructure, increased peak-load capacity, utilization and efficiency improvements, improved reliability, scalability and elasticity and improved security, among other benefits. Another notable benefit to web based filter system 10 using cloud computing module 22 that employs cloud computing principles allows the web based filter system 10 provides the benefit of allowing software 26 and/or filters 28 to be easily modified and adapted as a centralized location. That is, by having web filter software applications 16 and routers 18 communicate with General API 80 for filtering logic and direct some or all internet traffic to Traffic Transport Mechanism 24 of cloud computing module 22 the operation of the system 10 and its processes can be modified and improved without having to reach out to install improved software, firmware or code on internet enabled devices 14 and/or routers 18.

Transport Mechanism:

In the arrangement shown, as one example, web filter system 10 could include Transport Mechanism 24 which may include a VPN, Proxy, and/or any other possible mechanism for securely transporting internet traffic from Internet Enabled Device 14 to Cloud Computing Module 22. Transport Mechanism 24 is formed of any device that receives and processes internet requests from internet enabled device 14. In the arrangement shown, as one example, VPN server, also known as a virtual private network (VPN) extends a private network across a public network, such as the internet. It enables data to be sent and received across shared or public networks as if the computing devise were directly connected to the private network. The VPN server facilitates a secure connection and secure transfer of information and data.

Software:

In the arrangement shown, as one example, web filter system 10 includes software 26. Software 26 is formed of any information, executable instructions or computer code that facilitates operation of the computing devices of web based filter system 10. While software 26 is shown being connected to Transport Mechanism 24, software 26 may be located in any position or in multiple positions.

Filter:

In the arrangement shown, as one example, web filter system 10 includes filter 28. Filter 28 is formed of any filtering device or system configured to restrict or control content that is returned to a user's internet enabled device 14 in response to an internet request or search on the internet 38. In one arrangement, filter 28 is configured to determine whether web content 40 sought after by a user 12 by submitting an internet request to Transport Mechanism or General API 80 can be classified as acceptable internet content 42 or harmful internet content 44. When harmful internet content 44 is detected, the harmful internet content 44 is blocked either by blocking just the harmful portion of content or by wholly blocking access to the entire web site, web page or web content 40. In one arrangement, as is shown, filter 28 includes a DNS Filter 30, a URL filter 32, a content filter 34 and a Domain Categorization Filter 35. It is hereby contemplated that any number of filters 28 may be used as well as any other type of filter may be used.

DNS Filter:

In the arrangement shown, as one example, web filter system 10 includes DNS filter 30. In one arrangement, as is shown filter 28 includes a DNS filter 30. DNS stands for “Domain Name Server” (“DNS”) which is the internet's equivalent to a phone book. They maintain a directory of domain names and translate them to Internet Protocol (IP) addresses. When an internet request comes into Transport Mechanism 24 from internet enabled device 14 to retrieve information from a website, DNS filter 30 is configured to check the requested domain against one or more lists of known domains that include harmful internet content 44. If the requested domain is on the blacklist, the DNS filter 30, wholly or partially, blocks access to the requested website or web content 40. As such, in a way, DNS filter 30 cross-checks the requested domain name with a blacklist.

URL Filter:

In the arrangement shown, as one example, web filter system 10 includes URL filter 32. In one arrangement, as is shown filter 28 includes a URL filter 32. URL stands for “Uniform Resource Locator” (“URL”), and is used to specify addresses on the internet. A URL is the fundamental network identification for resources connected to the web. Many URLs include words or phrases that provide insight about the web content 40 located at the URL. When an internet request comes into Transport Mechanism 24 from internet enabled device 14 to retrieve information from a website, URL filter 32 is configured to check or scan the URL of the requested website for various keywords or phrases. If the URL filter 32 determines that more than a threshold amount (based on an algorithm) of prohibited keywords or phrases are included in the URL, the URL filter 32, wholly or partially, blocks access to the requested website or web content 40. As such, in a way, URL filter 32 cross-checks the requested URL with a list of prohibited keywords or phrases.

Content Filter:

In the arrangement shown, as one example, web filter system 10 includes content filter 34. In one arrangement, as is shown filter 28 includes a content filter 34. When an internet request comes into Transport Mechanism 24 from internet enabled device 14 to retrieve information from a website, content filter server 34 is configured to check or scan the content of the requested website for various keywords or phrases or even images. If the content filter 34 determines that more than a threshold amount (based on an algorithm) of prohibited keywords or phrases are included in the web content 40 of the requested website, the content filter 34, wholly or partially, blocks access to the requested website or web content 40.

In one arrangement, content filter 34 requests the requested webpage on behalf of the user 12. The webpage is returned to the cloud (cloud computing module 22) and the content filter 34 scans the web content 40 for prohibited content, such as keywords, phrases or images. If less than a threshold amount of prohibited content is detected, the web content 40 is provided to the user. If, on the other hand, more than a threshold amount of prohibited content is detected, the web content 40 is blocked.

Domain Categorization Filter:

In the arrangement shown, as one example, web filter system 10 includes Domain Categorization Filter 35. When an internet request comes into Transport Mechanism 24 from internet enabled device 14 to retrieve information from a website, or a call is made to General API 80 about a specific web domain, Domain Categorization filter 35 is configured to check the categorization of the domain by checking a cache of domain categorizations in Databases 50, and alternatively contact third party providers to categorize the domain requested. If the Domain Categorization filter 35 determines that the category the domain belongs to is prohibited by the configuration in Account 60, the Domain Categorization filter 35, blocks the traffic if received through Transport Mechanism 24 or if queried through General API 80 gives a response telling Software Application 16 or Router 18 to block all traffic with the domain.

Proxy Server:

In the arrangement shown, as one example, web filter system 10 includes proxy server 36. In one arrangement, as is shown proxy server 36 is positioned between filter 28 and the requested web content 40 retrieved through internet 38. Proxy server acts as an intermediary between internet requests from user 12 and the web content 40 from another server. In this way, use of proxy server 36 provides anonymity and security. The use of proxy server 36 also facilitates the functionality of returning the requested webpage to the cloud computing module 22 where it is scanned or filtered by filter 28 before it is provided to user 12.

Internet:

In the arrangement shown, as one example, web filter system 10 includes use of the internet 38. In one arrangement, as is shown internet 38 is positioned between proxy server 36 and the web content 40 requested by the user 12. However, the internet 38 may be, in a way, considered to be between any two electronic devices of the system 12. The internet is the global system of interconnected computer networks that use the internet protocol suite (TCP/IP) to link devices worldwide. It is a network of networks that consist of private, public, academic, business, and governmental networks of local to global scope, linked by a broad array of electronic, wireless, and optical networking technologies. In the arrangement shown, the internet 38 provides access to web content 40.

Web Content:

In the arrangement shown, as one example, web filter system 10 includes web content 40. In one arrangement, as is shown web content 40 is the content or information requested by user 12 through their internet request, such as by performing a search on a search engine, by typing in a domain name, by selecting a hyperlink, or initiating information transfer to internet enabled device 14 by any action. Web content 40 may be a website, video, audio, images, text, any combination of these, or any other content. Web content 40 may include acceptable internet content 42. Web content 40 may also include harmful internet content 44.

Acceptable internet content 42 is any web content 40 that does not exceed the threshold limits established by the web filter system 10. More specifically, acceptable internet content 42 is any web content 40 that is not blocked by filter 28. In contrast, harmful internet content 44 is any web content 40 that does exceed the threshold limits established by the web filter system 10. More specifically, harmful internet content 42 is any web content 40 that is blocked by filter 28.

Remote Collector:

In the arrangement shown, as one example, web filter system 10 includes remote collector 46. Remote collector 46 is any system or device configured to receive and collect log files 62 from filter 28. Remote collector 46 is configured to listen for incoming log files 62 from filter 28. Remote collector 46 is also configured to transmit these log files 62 to backend job 48.

When an internet request submitted by user 12 is blocked by filter 28, a log file 62 is transmitted by filter 28 to remote collector 46, which is in one arrangement a syslog message. The following is one example a log file 62:

Jan 6 00:21:34 vpn1 process[30965]: “2017.1.6 0:21:34”,“-”,“172.18.0.10”,“http://example.com”,“*DENIED* Blocked site: example.com”,“GET”,“0”,“0”,“Banned Sites”,“1”,“403”,“-”,“ ”,“ ”,“ ”,“ ”,“-”,“-”,“ ”

As is shown in this example, log file 62 includes the date 64 of the log file 62, the time 66 of the log file 62, the domain name 68 of the log file 62, and the reason 70 for the log file 62, the user's information 72, among other information.

Backend Job:

In the arrangement shown, as one example, web filter system 10 includes backend job 48. Backend job 48 is any system or device configured to receive or pull log files 62 from remote collector 46. Backend job 48 is configured to scan log files 62 to determine if an internet request was blocked by filter 28, which results in a log file 62 stating that it was blocked. When a blocked log file 62 is detected, information regarding the blocked log file 62 is transmitted to message API 52. Backend job 48 is also configured to transmit log files 62 to database 50 for storage.

Database:

In the arrangement shown, as one example, web filter system 10 includes database 50. Database 50 is any system or device configured to receive or pull log files 62 from backend job 48 or remote collector 46 and stores them in memory for later retrieval and use.

Message API & Message:

In the arrangement shown, as one example, web filter system 10 includes message API 52. “API” means application programming interface. Message API 52 is any system or device configured to receive or pull log files 62 from backend job 48, remote collector 46, or direct web requests and is further configured to construct and transmit message 54 to the electronic device 56 to one or more accountability partners 58 of user 12 when the system 10 detects that the user 12 submits an internet request for harmful internet content 44 that was blocked by filter 28. In the arrangement shown, message API 52 is also configured to associate the information contained within log file 62 to the account 60 of user 12 and from this information determine where to send message 54. The following is one example of a message 54:

NetAngel has blocked a site on MM/DD/YYYY, HH:MM: “John Doe Router”. Blocked site: http://example.com. Category: Banned Sites.

Message 54 is any message sent to accountability partner 58 that informs accountability partner 58 that user 12 submitted an internet request for harmful internet content 44 that was blocked by filter 28 or that the Software Application 16, Router 18, or any other component of system 10 has been tampered with or altered which may inhibit the ability of system 10 to properly filter traffic. Message 54 includes any information needed to inform accountability partner 58 of the internet activity of user 12. In the arrangement shown, message 54 includes the date 64, time 66, the name of the internet enabled device 14 that submitted the blocked internet request, the domain name 68 of the blocked site, and a description of why the website was blocked. With this information the accountability is armed with all the necessary information to discuss this matter with user 12.

In one arrangement, system 10 transmits message 54 instantly with when filter 28 blocks the internet request. In an alternative arrangement, system 10 transmits message 54 within one, two, three, four, five, six, seven, eight, nine, ten, eleven, twelve, thirteen, fourteen or fifteen seconds of when filter 28 blocks the internet request. In another alternative arrangement, system 10 transmits message 54 within thirty seconds to a minute of when filter 28 blocks the internet request. For the purposes of this application the word instant or instantly, or practically instantly or simultaneously or in real time is defined to include events that occur at the exact same moment in time. For the purposes of this application these words are also defined to include events that occur within a practical amount of time or reasonable amount of time or with a reasonable amount of delay between events to enable the necessary electronic steps or processes to occur. As these words are to be given a broad definition, which accounts for a practical amount of delay or pause, unless explicitly stated otherwise with a more precise definition.

Accountability Partner:

Accountability partner 58 is any person or persons that are designated to be notified by message 54 when user 12 submits an internet request for web content 40 that is deemed to qualify as harmful internet content 44 by filters 28. Accountability partner 58 may be a parent, guardian, brother, sister, an addiction program partner, or any other person or group of people that care about user 12. When accountability partner 58 receives message 54 to their electronic device 56 it is practically instantaneous with or simultaneous with the user 12 submitting the internet request for web content 40 that is deemed to qualify as harmful internet content 44 by filters 28. Or, alternatively, when accountability partner 58 receives message 54 to their electronic device 56 it is practically instantaneous with or simultaneous with a blocked message 74 being transmitted to the internet enabled device 14 of the user 12. Said another way, accountability partner 58 is informed of the prohibited internet searching contemporaneously with when the searching is occurring. This allows the accountability partner 58 to intervene at the moment that the nefarious conduct is occurring and to mitigate damage and further prohibited conduct.

Blocked Message:

In one arrangement, when an internet request is submitted by user 12 for web content 40 that is deemed to qualify as harmful internet content 44 by filters 28 a blocked message 74 is transmitted to the internet enabled device 14 of the user 12. The blocked message 74 informs the user 12 that the requested information has been blocked. The blocked message 74 may also include any additional information such as the reason why the internet request was blocked.

In Operation—Router Configuration:

A user 12 interested in blocking harmful internet content 44 from all internet enabled devices 14 on their home electronic network 20A installs router 18 on their home electronic network 20A. When a user 12 connects their internet enabled device 14 to home electronic network 20A (regardless of whether it is a smart phone, tablet, laptop, desktop computer, smart watch, gaming console or any other internet enabled device 14) all internet requests and internet traffic go through router 18.

When user 12 submits an internet request for web content 40, router 18 is configured to inspect all network traffic and communicate with General API 80 which communicates with Domain Categorization Filter 35 to determine whether to allow or block web content 40, or redirect web content 40 through Transport Mechanism 24 to Filter 28 which performs DNS filtering using DNS filter 30, URL filtering using URL filter 32 and content filtering using content filter 34.

In the event that filter 28 determined the requested web content 40 was blocked for exceeding the threshold of filter 28 blocked message 74 is returned to the user's internet enabled device 14. The requested web content 40 may be wholly or partially blocked depending on the particular situation.

A log file 62 is generated and transmitted to remote collector 46 in association with the user's internet request for web content 40. This log file 62 is transmitted to backend job 48. Backend job 48 scans the log file 62 to determine whether the requested web content 40 was blocked for exceeding the threshold of filter 28 and therefore is considered harmful internet content 44.

If a log file 62 is determined to indicate that an internet request was blocked for exceeding the threshold of filter 28 and therefore is considered harmful internet content 44, message API 52 associates the log file 62 with a user 12 and the user's accountability partner(s) 58. Message API 52 configures message 54 to include the desired information regarding the user's internet activity and transmits message 54 to electronic device 56 of accountability partner(s) 58. With this information, which is delivered instantly, practically instantly, or in real time, or within a short practical delay caused by the electronic processing required ranging between a fraction of a second to seconds to a minute, with the user's internet request and/or the return of the blocked message 74, accountability partner(s) 58 can intervene in a timely fashion in an attempt to help the user 12, prevent interest from turning into addiction and in an attempt to prevent further harm from occurring to the user 12.

In Operation—Web Filter Software Application Configuration:

A user 12 interested in blocking harmful internet content 44 from their internet enabled device 14, regardless of what electronic network 20 they use to access the internet, installs web filter software application 16 on their internet enabled device 14. Multiple internet enabled devices 14 may be associated with a single user 12 by establishment of an account 60 that ties the user's name and account to multiple devices (such as smart phones, tablets, laptops, desktop computers, smart watches and the like) and then installing web filter software application 16 on each of these internet enabled devices 14 and associating them with the account 60 of the user 12.

When user 12 submits an internet request for web content 40 through one of their enrolled internet enabled devices 14 web filter software application 16 is configured to inspect all internet traffic and either allow, block, or redirect it through Traffic Transport Mechanism 24 to Filter 28 as dictated by responses from General API 80 regardless of the electronic network 20 that is used to access the internet. If traffic is redirected to Transport Mechanism 24, Transport Mechanism 24 transmits the internet request for web content 40 to filter 28. Filter 28 performs DNS filtering using DNS filter 30, URL filtering using URL filter 32 and content filtering using content filter 34. In the event that filter 28 determined the requested web content 40 was blocked for exceeding the threshold of filter 28 blocked message 74 is returned to the user's internet enabled device 14. The requested web content 40 may be wholly or partially blocked depending on the particular situation.

A log file 62 is generated and transmitted to remote collector 46. This log file 62 is transmitted to backend job 48. Backend job 48 scans the log file 62 to determine whether the requested web content 40 was blocked for exceeding the threshold of filter 28 and being considered harmful internet content 44.

In the event that filter 28 determined the requested web content 40 was blocked for exceeding the threshold of filter 28 blocked message 74 is returned to the user's internet enabled device 14. The requested web content 40 may be wholly or partially blocked depending on the particular situation.

In the event that Software Application 16 or Router 18 blocks web content 40 as dictated by responses from General API 80, blocked message 74 is returned to the user's internet enabled device 14. The requested web content 40 may be wholly or partially blocked depending on the particular situation.

If a log file 62 is determined to indicate that an internet request was blocked for exceeding the threshold of filter 28 and therefore is considered harmful internet content 44, message API 52 associates the log file 62 with a user 12 and the user's accountability partner(s) 58. Message API 52 configures message 54 to include the desired information regarding the user's internet activity and transmits message 54 to electronic device 56 of accountability partner(s) 58. With this information, which is delivered instantly, practically instantly, or in real time, or within a short practical delay caused by the electronic processing required ranging between a fraction of a second to seconds to a minute, with the user's internet request and/or the return of the blocked message 74, accountability partner(s) 58 can intervene in a timely fashion in an attempt to help the user 12, prevent interest from turning into addiction and in an attempt to prevent further harm from occurring to the user 12.

If Software Application 16 or Router 18 determines from responses from General API 80, that web content 40 is Harmful Internet Content 44, Software Application 16 or Router 18 uploads all locally stored internet traffic history to General API 80 which communicates with message API 52 to send message 54 to include the desired information regarding the user's internet activity and transmits message 54 to electronic device 56 of accountability partner(s) 58. With this information, which is delivered instantly, practically instantly, or in real time, or within a short practical delay caused by the electronic processing required ranging between a fraction of a second to seconds to a minute, with the user's internet request and/or the return of the blocked message 74, accountability partner(s) 58 can intervene in a timely fashion in an attempt to help the user 12, prevent interest from turning into addiction and in an attempt to prevent further harm from occurring to the user 12.

Further Reasons for Messaging the User's Accountability Partner(s):

It is obviously important for the user's accountability partner(s) 58 to be informed of when internet requests submitted by user 12 are blocked due to harmful internet content 44 so that the accountability partner(s) 58 is made aware of user's attempt to view harmful internet content 44. However, the web filter system is also configured to transmit messages 54 to the user's accountability partner(s) 58 when various other events occur which may be signs of nefarious conduct or the user's attempts to circumvent the web filter system 10.

One such event is when the user's internet enabled device 14 becomes unprotected, meaning that the web filter software application 16 was uninstalled, disabled or deleted from the user's internet enabled device 14. When this occurs, a message 54 is transmitted to the user's accountability partner(s) 58 electronic device 56 informing them that the internet enabled device 14 is no longer protected by the web filter system 10. This allows the accountability partner(s) 58 to investigate the reasons why the internet enabled device 14 is no longer protected by the web filter system 10 which may simply be a malfunction, or it may be for legitimate reasons, or it may be because the user 12 is trying to circumvent the web filter system 10.

Another such event is when the user's changes or deletes the accountability partner(s) 58 notification endpoint, such as a phone number, email address, or other contact information that facilitates the transmission of message 54 to accountability partner(s) 58. When this occurs, a message 54 is transmitted to the user's accountability partner(s) 58 electronic device 56 informing them of the change. In one arrangement, a confirmation is requested from the accountability partner(s) 58 that this change is desired or authorized which if confirmed the change is allowed to be made and if denied, or not confirmed, or not confirmed within a predetermined amount of time, or not confirmed with a secret PIN or key, the change is not allowed to be made. This may take the form of a text message, a voice message, an email, a message on an app or other program, or any other message. This allows the accountability partner(s) 58 to investigate the reasons why the accountability partner(s) 58 phone number or other contact information that facilitates the transmission of message 54 to accountability partner(s) 58 which may be for legitimate reasons, or it may be because the user 12 is trying to circumvent the web filter system 10.

Another such event is when the user 12 changes or deletes their own phone number or internet enabled device 14 on the web filter system 10. When this occurs, a message 54 is transmitted to the user's accountability partner(s) 58 electronic device 56 informing them of the change or deletion. In one arrangement, a confirmation is requested from the accountability partner(s) 58 that this change is desired or authorized which if confirmed the change is allowed to be made and if denied the change is not allowed to be made. This allows the accountability partner(s) 58 to investigate the reasons why the user changed or deleted their own phone number or internet enabled device 14 on the web filter system 10 which may be for legitimate reasons, or it may be because the user 12 is trying to circumvent the web filter system 10.

In one arrangement, whenever an accountability partner(s) 58 notification endpoint (such as a phone number, email address, link to an app, or the like) changes, a message 54 is transmitted to both the old notification endpoint and the new notification endpoint. In addition, when an accountability partner(s) notification endpoint is changed or added to the web filter system 10 a message 54 is sent to the accountability partner(s) electronic device 56 requesting a confirmation in return thereby confirming the change was appropriate and accepted.

Notification Endpoint:

a Notification Endpoint is defined as any means an Accountability Partner 58 may use to receive notifications. This includes but is not limited to phone number for SMS text messages or E-mail address.

These are only some of the additional reasons why a message 54 is sent to accountability partner 58. It is contemplated that any other reason or event that warrants transmission of a message 54 to accountability partner 58 is hereby contemplate.

It is hereby contemplated that the web filter system 10 may be used to block any harmful internet content 44, such as but not limited to: adult & sexually explicit content; drug related content; alcohol related content; gambling related content; hacking related content; Warez related content; violence related content; hate related content; racism related content; sexism related content; terrorism related content; extremism related content or any other harmful internet content 44. Filter 28 may be custom tailored to block any combination of these categories of harmful internet content 44 or all of these categories of harmful internet content 44.

In one arrangement, filter 28 is continually learning. That is, as filter 28 determines that various internet requests are deemed to contain harmful internet content 44, filter 28 is updated to recognize these websites and web content 40 as harmful internet content 44. In this way, the continual learning process of filter 28 speeds the filtering process and improves the accuracy of the filtering process.

Software Application 16 or Router 18 may be configured in connection with General API 80 to filter Web Content 40 to the specific specifications based on domain category or domain itself for each Internet Enabled Device 14 or Router 18. This allows User 12 to customize what is considered Harmful Internet Content 44 for each specific Internet Enabled Device 14 or Router 18.

From the above discussion it will be appreciated that the web filter system presented herein improves upon the state of the art.

Specifically, the web filter system presented herein: involves the user's support network, such as an accountability partner or parent in the filtering and blocking process; provides early detection of harmful internet activity provides instant alerts to the user's support network, such as an accountability partner or parent of harmful internet activity; is easy to use; is difficult to work around; does not substantially inhibit safe internet activities; can be utilized with practically any internet enabled device; helps prevent addiction; blocks harmful internet content; helps to prevent or stop addiction relapses from occurring; is relatively inexpensive to apply; does not substantially slow down internet operation; can help prevent interest from turning into addiction, among countless other advantages and improvements.

It will be appreciated by those skilled in the art that other various modifications could be made to the device without parting from the spirit and scope of this invention. All such modifications and changes fall within the scope of the claims and are intended to be covered thereby.

What is claimed:

1. A method of preventing a user from accessing harmful internet content, the steps comprising;
providing a web filter software application;
installing the web filter software application on an internet enabled device of a user, wherein the web filter software application facilitates the inspection of traffic and communicates with an Application Programming Interface (API) to determine whether to allow, block, or redirect some or all of the traffic through a transport mechanism to a filter;
submitting an internet request for web content by the user on the internet enabled device;
inspecting the internet request for web content from the user's internet enabled device;
processing the internet request for web content using a filter;
determining whether the web content of the internet request includes harmful internet content;
blocking the harmful internet content;
sending a message to an electronic device of an accountability partner if it is determined that the web content of the internet request is deemed to include harmful internet content.

2. The method of claim 1, wherein the message is sent to the electronic device of an accountability partner is a text message, voice message, or E-mail notification.

3. The method of claim 1, wherein the message is sent to the electronic device of an accountability partner is a text message, voice message, or E-mail notification that is sent simultaneously to the accountability partner as the requested web content is blocked to the user.

4. The method of claim 1, wherein the message is sent to the electronic device of an accountability partner in real-time with the determination that the requested web content included harmful internet content.

5. The method of claim 1, wherein the message is sent to the electronic device of an accountability partner practically instantly with the determination that the requested web content includes harmful internet content.

6. The method of claim 1, wherein the message to an electronic device of an accountability partner includes the URL of the blocked web content.

7. The method of claim 1, wherein the message to an electronic device of an accountability partner includes a description identifier of the blocked content.

8. The method of claim 1, wherein the filter includes a DNS filter that compares an address of the requested web content addresses known to contain harmful web content and blocks web content from addresses known to contain harmful web content.

9. The method of claim 1, wherein the filter includes a URL filter that scans a URL of the requested web content for keywords in the URL and blocks web content that includes various keywords in the URL.

10. The method of claim 1, wherein the filter includes a content filter that scans the web content of the internet request for keywords and blocks web content that includes various keywords in the content of the web content.

11. A method of preventing a user from accessing harmful internet content, the steps comprising;
providing a web filter software application;
installing the web filter software application on an internet enabled device of a user, wherein the web filter software application facilitates the inspection of traffic and communicates with an Application Programming Interface (API) to determine whether to allow, block, or redirect some or all of the traffic through a transport mechanism to a filter;
submitting an internet request for web content by the user on the internet enabled device;
inspecting the internet request for web content and communicating with the API to determine whether to allow, block or redirect some or all of the traffic through a transport mechanism to a filter;
processing the internet request for web content using a filter;
filtering the web content using a DNS filter, a URL filter, a content filter and a domain categorization filter;
determining whether the web content of the internet request includes harmful internet content;
blocking the harmful internet content;
sending a message to an electronic device of an accountability partner if it was determined that the web content of the internet request included harmful internet content.

12. The method of claim 11, wherein the message is sent to the electronic device of an accountability partner is a text message, voice message, or E-mail notification.

13. The method of claim 11, wherein the message is sent to the electronic device of an accountability partner is a text message, voice message or E-mail notification, that is sent simultaneously to the accountability partner as the requested web content is blocked to the user.

14. The method of claim 11, wherein the message is sent to the electronic device of an accountability partner in real-time with the determination that the requested web content included harmful internet content.

15. The method of claim 11, wherein the message to an electronic device of an accountability partner includes the URL of the blocked information.

16. The method of claim 11, wherein the message to an electronic device of an accountability partner includes a description identifier of the blocked content.

17. A method of preventing a user from accessing harmful internet content, the steps comprising;
providing a web filter software application configured to inspect traffic and communicate with an Application Programming Interface (API) to determine whether to allow, block, or redirect some or all of the traffic through a transport mechanism to a filter;
installing the web filter software application on an internet enabled device of a user;
establishing a home electronic network using a router configured to direct internet requests to the transport mechanism;
submitting an internet request for web content by the user on the internet enabled device;
directing the internet request for web content from the user's internet enabled device to the transport mechanism through the router when the internet enabled device is connected to the home electronic network, and directing the internet request for web content from the user's internet enabled device to the transport mechanism through a mobile electronic network using the web filter software application when the internet enabled device is connected to a mobile electronic network;
processing the internet request for web content using a filter;
filtering the web content using the filter;
determining whether the web content of the internet request includes harmful internet content;
blocking the harmful internet content;
sending a message to an electronic device of an accountability partner if it is determined that the web content of the internet request includes harmful internet content.

18. The method of claim 17, wherein the message is sent to the electronic device of an accountability partner is a text message that is sent simultaneously to the accountability partner as the requested web content is blocked to the user.
